(19) United States
(12) Patent Application Publication
(10) Pub. No.: US 2019/0133347 A1
(43) Pub. Date: May 9, 2019

(54) INTERLOCKING MOUNTING APPARATUS

(71) Applicant: 3M INNOVATIVE PROPERTIES COMPANY, St. Paul, MN (US)

(72) Inventor: Jon A. Kirschhoffer, Stillwater, MN (US)

(21) Appl. No.: 16/095,915

(22) PCT Filed: Apr. 19, 2017
(86) PCT No.: PCT/US2017/028410

§ 371 Date: Oct. 23, 2018

Related U.S. Application Data
(60) Provisional application No. 62/367,848, filed on Jul. 28, 2016.
(60) Provisional application No. 62/327,063, filed on Apr. 25, 2016.

(51) Int. Cl. A47G 1/17; F16B 5/00; F16B 5/07; A47G 1/20; F16M 13/02

(52) U.S. Cl. CPC A47G 1/175; F16B 5/0012; F16M 13/022; A47G 1/20; F16B 5/07

(57) ABSTRACT

An interlocking mounting apparatus includes at least two portions interlocked together and at least one of the two portions having a mounting device. The interlocking mounting apparatus capable of holding more weight from the mounting device than the portion having the mounting device alone.

### BACKGROUND

A variety of solutions exists for hanging picture frames from walls. One of the more difficult solutions for a consumer to manage is finding a stud behind a wall where the consumer can directly insert a screw associated with the picture bracket or hook. This requires a consumer to be capable of properly locating the stud; have some assurance that the location of the screw is not on a far edge of stud, such that is may splinter the stud; drill through the drywall and into the stud, and alter the location on the wall where the consumer wanted to hang a picture frame to a location that is less ideal but includes a located stud.

Another solution entails drilling a hole into the drywall and inserting a plastic screw expander that expands behind the drywall when a screw is inserted for the picture bracket or hook. This requires the consumer to accurately measure where to drill and properly handle the plastic expanders which often bend and damage easily when inserted into the predrilled drywall.

Recently, solutions for hanging picture brackets and hooks have become more user friendly and less invasive to the drywall. For example, consider the Command™ based product offerings distributed by 3M Company. The Command™ family of stretch releasable adhesive products permit consumers to adhere a dual-sided adhesive strip to any desired location on a wall and add and remove hooks as needed to the strips. Consumers can easily handle the strips. However, the hooks adhered to the strips have weight limitations, which consumers often fail to pay attention to. As a result, some consumers overload the hooks only to later discover that the hooks failed and their pictures have fallen to the floor.

The need therefore exists for consumer-friendly solutions to hanging objects of greater weight from hooks and minimizing hook failures.

### SUMMARY

In various embodiments, apparatuses and methods are provided for interlocking mounting devices.

According to an embodiment, an interlocking mounting apparatus is provided. The interlocking mounting apparatus includes: a first portion, a second portion having a mounting device. The first portion is adapted to interlock with the second portion to form a single mounting apparatus.

### BRIEF DESCRIPTION OF THE DRAWINGS

FIG. 1 is a diagram of a detached interlocking mounting apparatus, according to an example embodiment.

FIG. 2 is a diagram of an interlocking mounting apparatus with three portions, according to an example embodiment.

FIG. 3 is a diagram of an interlocking mounting apparatus with seven portions interlocked by square teeth, according to an example embodiment.

FIG. 4 is a diagram of another interlocking mounting apparatus with seven portions interlocked by wave-shaped teeth, according to an example embodiment.

FIG. 5 is a diagram of an interlocking mounting apparatus with three portions interlocked by pins, according to an example embodiment.

FIG. 6 is a diagram of a transparent view of the interlocking mounting apparatus of the FIG. 5, according to an example embodiment.

FIG. 7 is a diagram of a detached mounting apparatus with three portions, according to an example embodiment.

FIG. 8 is a diagram of backsides of a three portion interlocking mounting apparatus interlocked by teeth with dual-sided adhesive strips, according to an example embodiment.

FIG. 9 is a diagram of a backside of a single portion of an interlocking mounting apparatus, according to an example embodiment.

FIG. 10 is a diagram of a backside view of a three portion interlocking mounting apparatus interlocked by pins with dual-sided adhesive strips, according to an example embodiment.

FIG. 11 is a diagram of five portion interlocking mounting apparatus holding a twenty pound weight, according to an example embodiment.

FIG. 12 is a diagram of a three portion interlocking mounting apparatus holding a twenty pound weight, according to an example embodiment.

FIG. 13A is a diagram of vertically stacked interlocking mounting apparatuses, according to an example embodiment.

FIG. 13B is a diagram of vertically stacked interlocking mounting apparatuses, according to another example embodiment.

FIG. 14 is a diagram of a method for operating an interlocking mounting apparatus, according to an example embodiment.

FIG. 15 is a diagram of a method for manufacturing an interlocking mounting apparatus, according to an example embodiment.

### DETAILED DESCRIPTION

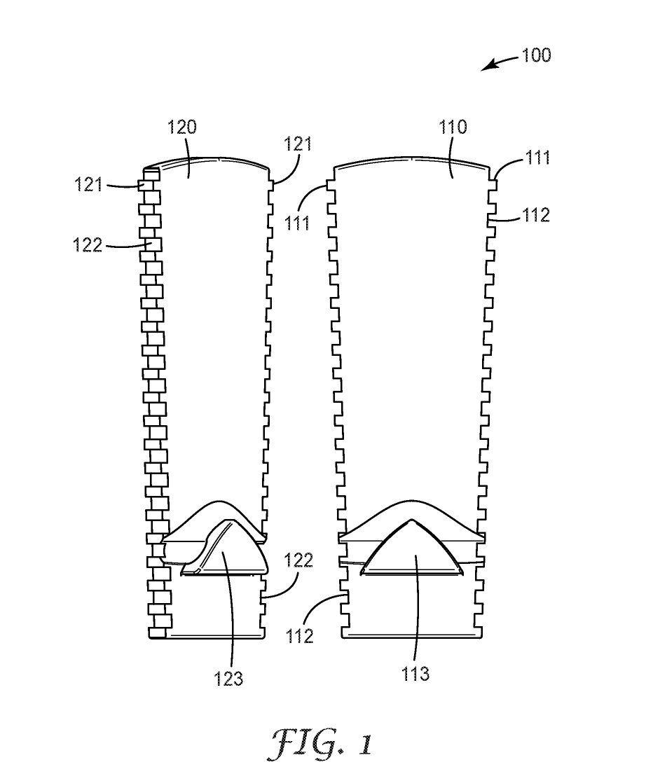

FIG. 1 is a diagram of a detached interlocking mounting apparatus 100, according to an example embodiment.

As used herein the term “portion” may be used synonymously and interchangeably with “unit.”

The detached interlocking mounting apparatus 100 includes a first portion 110 and a second portion 120. The first portion 110 includes a plurality of protruding structures 111 separated from one another by recesses (gaps) 112. The protruding structures 111 are aligned along two sides of the first portion 110. Correspondingly, the second portion 120 includes a plurality of protruding structures 121 separated from one another by recesses (gaps) 122. Again, the protruding structures 121 are aligned along two sides of the second portion 120.

In the detached interlocking mounting apparatus 100 depicted in the FIG. 1, the first portion 110 includes a mounting device 113 and the second portion 120 includes a mounting device 123. However, it is to be noted that with respect to the FIG. 1 and the other FIGS. discussed herein, the interlocking mounting apparatuses can have just one portion of many interlocked portions that includes a mounting apparatus.

Each portion 110 and 120 can be made of metal, plastic, or a combination of metal and plastic.

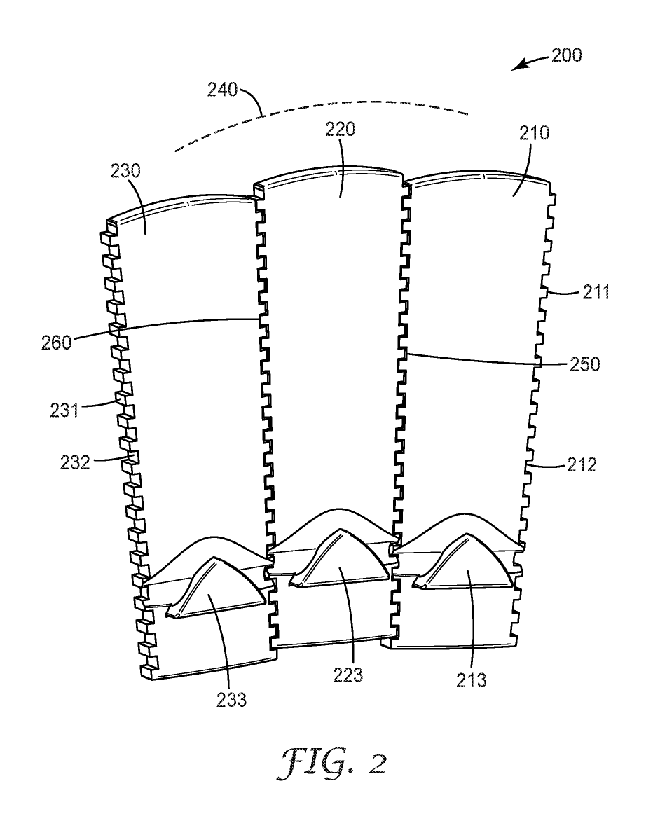

FIG. 2 is a diagram of an interlocking mounting apparatus 200 with three portions, according to an example embodiment.

The interlocking mounting apparatus 200 illustrates three portions 210, 220, and 230 interlocked with one another to form a single interlocking mounting apparatus 200.

The first portion 210 includes a plurality of protruding members 211 with recesses (spaces or gaps) 212 between pairs of the protruding members 211. Similarly, the second portion 220 includes a plurality of protruding members on a first side of the second portion 220 that interlock (snap and/or bind) 250 with recesses (spaces or gaps) 212 of a first side of the first portion 210. A second side of the second portion 220 includes a plurality of protruding members on a second side of the second portion 220 that interlock (snap and/or bind) 260 with recesses (spaces or gaps) 232 of a first side of the third portion 230. Along a second side of the third portion 230 there are a plurality of protruding members 231 with recesses (spaces or gaps) 232 between pairs of protruding members 231.

The interlocking mounting apparatus 200, as illustrated, includes mounting devices, 213, 223, and 233, for the first portion 210, the second portion 220, and the third portion 230, respectively. Again, it is noted that just one of the portions (210, 220, or 230) need have a mounting device (213, 223, or 233).

In an embodiment, just the second portion 220 includes the mounting device 223 and the first portion 210 and the third portion 230 include no mounting apparatus.

The first portion 210 binds or interlocks 250 with the second portion 220; similarly, the first portion 210 binds or interlocks 260 with the third portion 230.

The interlocking mounting apparatus 200 shown in the FIG. 2 illustrates a binding mechanism utilizing square-shaped teeth as the protruding members 211 and 231 with the corresponding gaps or spaces 212 and 232 (it is to be noted that the second portion 220 shown in the FIG. 2 in between the first portion 210 and the third portion 230 also includes its own protruding members with corresponding gaps or spaces, although not specifically labeled separately in the FIG. 2).

The portions 210, 220, and 230 can be bound or interlocked 250 and 260 by aligning the square-shaped teeth along one side of a selected portion with corresponding gaps or receives along a side of another selected portion and snapping the two portions together.

In an embodiment, when a first side of the first portion 210 is snapped to a first side of the second portion 220, the first portion 210 is slightly offset so that a top of the first portion 210 is lower than a top of the second portion 220. Similarly, when a second side of the second portion 220 is snapped to a first side of the third portion 220, the third portion 230 is slightly offset so that a top of the third portion 230 is lower than the top of the second portion 220. This forms the interlocking mounting apparatus 200 in an arch-shape or arch formation 240 with the top of the second portion 220 being an apex of the interlocking mounting apparatus 200. The arch formation 240 assisting in distributing vertical forces hung from the mounting device 223 among each of the portions 210,220, and 230.

The mounting device 223 of the second portion 220 provides a mechanism for hanging an object from the interlocking mounting apparatus 200 when the interlocking mounting apparatus 200 is affixed to a wall, cabinet, or other vertical surface.

In an embodiment, the mounting devices 213, 223, 233 are shaped as a truncated triangle along a bottom of the interlocking mounting apparatus 200 (as illustrated in the FIG. 2).

In an embodiment, the mounting devices 213, 223, 233 are each or separately one of: a hook, a loop, a clip, and a sawtooth.

In an embodiment, the mounting devices 213, 223, and 233 are manufactured as separate components from the first portion 210, the second portion 220, and the third portion 230, respectively. In this embodiment, the mounting devices 213, 223, and 233 can be slid into premanufactured grooves of the first portion 210, the second portion 220, and the third portion 230 for attachment.

In an embodiment, the mounting devices 213, 223, and 233 are manufactured with the first portion 210, the second portion 220, and the third portion 230, respectively, as single integral components.

When the portions 210, 220, and 230 are interlocked with one another, the resulting interlocking mounting apparatus 200 can support hanging more weight vertically from the mounting device 223 than could any combination of two of the portions 210, 220, and/or 230 interlocked together. Moreover, any combination of two of the portions 210, 220, and/or 230 interlocked together can support hanging more weight vertically from the mounting devices (213, 223, and/or 233) than any single portion 210, 220, or 230.

In an embodiment, for each additional portion added to the interlocking mounting apparatus 200 the load bearing weight of the newly formed interlocking mounting apparatus 200 increases by a factor of 1.75 over what the interlocking mounting apparatus 200 originally supported before addition of a new portion.

In an embodiment, the portions 210, 220, and 230 are detachable from one another to form an interlocking mounting apparatus with just two portions or to completely disassemble the interlocking mounting apparatus into its three portions 210, 220, and 230 (as shown in the FIG. 1 with detached portions 110 and 120).

FIG. 3 is a diagram of an interlocking mounting apparatus 300 with seven portions interlocked by square teeth, according to an example embodiment.

The interlocking mounting apparatus 300 includes seven portions 310, 320, 330, 340, 350, 360, and 370 interlocked together to form the interlocking mounting apparatus 300. Again, each portion includes its own protruding members along that portion's sides with corresponding gaps or recesses between pairs of the protruding members. The protruding members 311 and 371 are illustrated along the non-connected sides of the first portion 310 and the seventh portion 370, respectively along with their corresponding gaps or recesses 312 and 372.

At least one mounting device is included on at least the center portion (fourth portion) 340 (not shown in the FIG. 3).

Each portion connects to at least one other portion for interlocking with one another (e.g., the first portion interlocked 315 to the second portion). The interlocked portions form an arch formation 390 with the apex being the top of the center (fourth) portion 340. The arch formation 390 assists in distributing vertical force hung from the mounting device 340 among each of the portions.

The center portion 340 also illustrates an adhesive strip 380 affixed to a backside of the center (fourth) portion 340 and extending down below a bottom of the center (fourth) portion 340. The adhesives strip 380 can comprise any suitable sheet, film, layer, etc. that comprises pressure-sensitive adhesive functionality on one or both oppositely-facing surfaces (i.e., a dual-sided adhesive strip). The adhesive strip 380 can be configured such that a first major adhesive surface can be exposed for bonding to the center portion 340, and such that a second major adhesive surface can be exposed for bonding to the wall to which the mounting apparatus 300 is to be mounted.

The adhesive strip 380 can be supplied to a user already bonded to the corresponding portion of the mounting apparatus; or, the adhesives strip 380 can be supplied separately to be bonded by the user. The adhesive strip 345 can comprise any suitable adhesive that is available in the form of a sheet, tape, roll, etc., from which a discrete piece of adhesive 380 can be obtained that is suitable for being contacted with and bonded to the requisite number of interlocking portions of mounting apparatus 300. Suitable adhesives thus include double-stick tapes, laminating adhesives, double-faced foam tapes, and the like, as are commonly known in the art.

In a particular embodiment, the adhesive strip 380 each comprise a stretch-release adhesive. Such a stretch-release property can allow the adhesive 380 to be securely attached to a surface and to be later removed from the surface without visual disfigurement of, or leaving adhesive residue on, the surface.

A suitable stretch-releasing adhesive can include an elastic backing, or a highly extensible and substantially inelastic backing, with a pressure-sensitive adhesive disposed (e.g., coated) thereupon. Or the stretch-releasing adhesive can be formed of a solid, elastic pressure-sensitive adhesive. Thus, in this context, the term “stretch-releasing adhesive” encompasses products that comprise a unitary, integral, or solid construction of adhesive (in addition to products that comprise a backing with separate layers of adhesive residing thereupon). Suitable exemplary stretch-releasing adhesives are described in U.S. Pat. No. 4,024,312 to Korpman; German Patent No. 33 31 016; U.S. Pat. No. 5,516,581 to Kreckel et al.; and PCT International Publication No. WO 95/06691 to Bries et al., the teachings of each of which are incorporated herein by reference. Such stretch-release adhesives can range, for example, from about 0.2 mm in thickness to about 2 mm in thickness.

If the adhesive strip 380 is a stretch-releasing adhesive, it can comprise a pull tab portion (e.g., an end of the adhesive piece 380 that does not comprise adhesive), which may be grasped by a user and pulled so as to activate the stretch-release properties of the adhesive when it is desired to detach the mounting apparatus 300 from a wall. Exemplary adhesive strips include, for example, any of the COMMAND™ brand products sold by 3M Company, St. Paul, Minn. including, for example, 3M's COMMAND™ picture hanging strips. In certain embodiments, adhesive strips are adhered to one or more sections of the mounting apparatus as well as to the wall. Methods of applying, using, and forming adhesive strips as well as composition of these adhesive strips of this general type are described in, for example, U.S. Pat. Nos. 5,672,402; 6,403,206; 7,781,056; 6,001471; 6,569,521; and 7,078,093, all of which are incorporated herein in their entirety.

The interlocking mounting apparatus 300 of the FIG. 3 illustrates that the interlocking mounting apparatus 200 of the FIG. 2 can be expanded by 4 additional portions for a total of seven portions. Again, each additional portion permits the resulting interlocking mounting apparatus to support more weight hung from the one or more mounting devices than an interlocking mounting apparatus having fewer portions interlocked together.

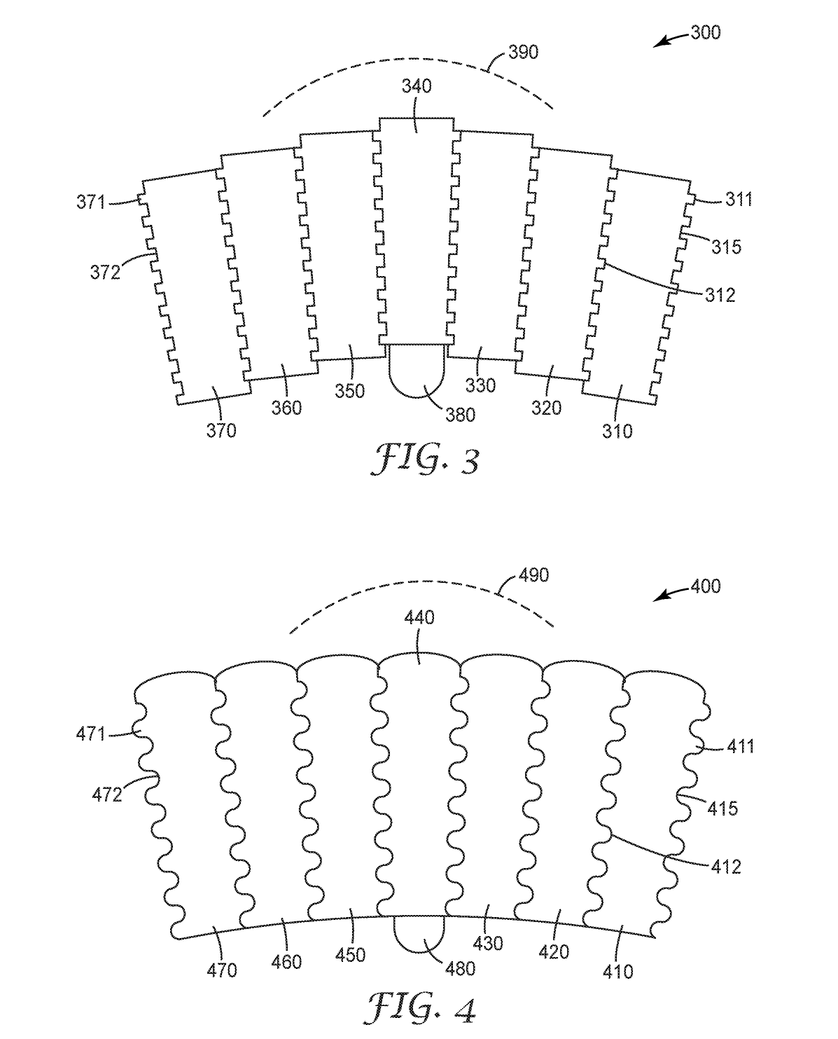

FIG. 4 is a diagram of another interlocking mounting apparatus 400 with seven portions interlocked by wave-shaped teeth, according to an example embodiment.

The interlocking mounting apparatus 400 includes seven portions: 410, 420, 430, 440, 450, 460, and 470. Each portion interlocked together using wave-shaped teeth (e.g., the first portion 410 interlocked 415 to the second portion).

The interlocking mounting apparatus 400 illustrates wave shaped teeth (illustrated as the protruding members 411 and 471 of the first portion and the seventh portion 472, respectively, along with their corresponding recesses or gaps 412 and 472 with just the non-interlocked sides of the first portion 410 and the seventh portion 470 labeled).

The interlocking mounting apparatus 400 also includes an adhesive strip (as discussed above) 480 on a backside of the center (fourth) portion 440 that extends below and is exposed under the center (fourth) portion 440.

The interlocking mounting apparatus 400 when assembled forms an arch formation 490. The arch formation 490 assisting in distributing vertical forces from weight hung from the mounting device 440 among each of the portions.

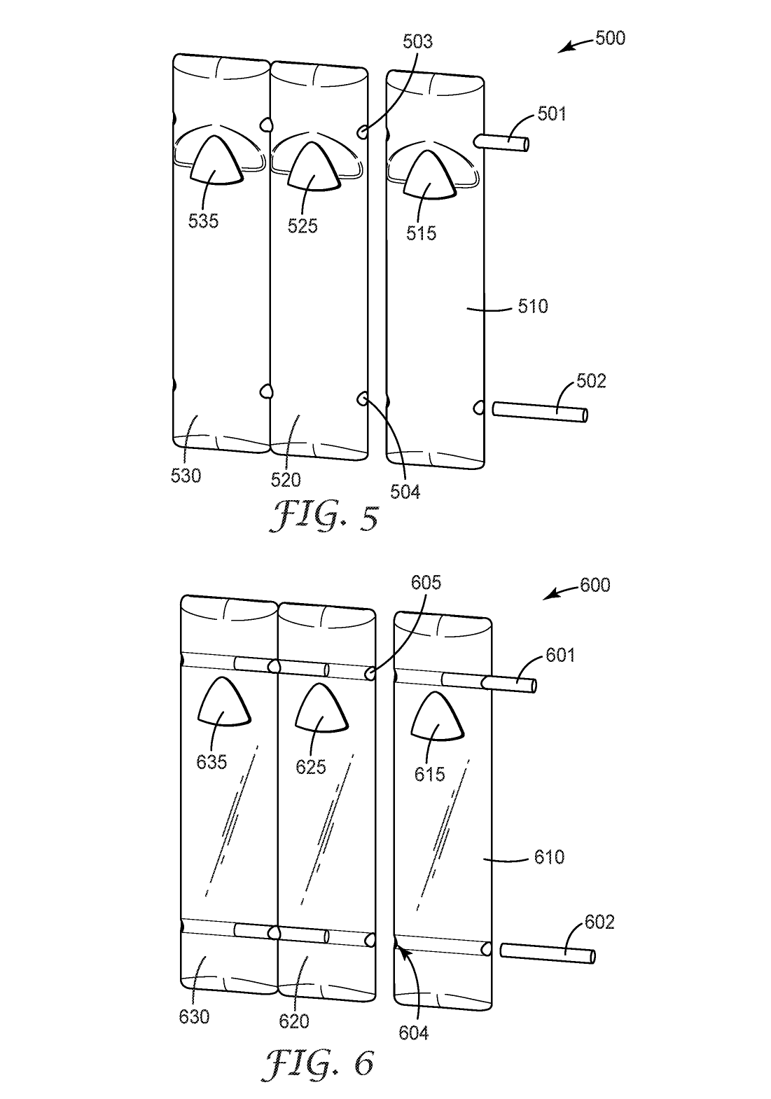

FIG. 5 is a diagram of an interlocking mounting apparatus 500 with three portions interlocked by pins, according to an example embodiment.

FIGS. 2-4 illustrate embodiments for interlocking a desired number of portions for mounting apparatuses interlocked through teeth with one another. The FIGS. 5-7 illustrate interlocking a desired number of portions for mounting apparatuses interlocked through one or more pins.

The interlocking mounting apparatus 500 includes a first portion 510, a second portion 520, and a third portion 530. Each portion 510, 520, and 530 includes one or more apertures (holes) (e.g., apertures 503 and 504 of the second portion labeled in the FIG. 5). The apertures adapted to permit one or more pins 501 and/or 502 to pass through the body of the portions 510, 520, and 530 for binding/interlocking the portions 510, 520, and 530 with one another to form the interlocking mounting apparatus 500.

Each portion 510, 520 and 530 includes a mounting device 515, 525, and 535, respectively. Although, it is again noted that in some embodiments only one portion or less than all portions include a mounting device.

In an embodiment, the mounting devices 515, 525, and 535 are situated along a top of each of the portions 510, 520, and 530, respectively (and as shown in the FIG. 5).

In an embodiment, the mounting devices 515, 525, and 535 are situated along a middle of each of the portions 510, 520, and 530, respectively (not shown in the FIG. 5).

In an embodiment, the mounting devices 515, 525, and 535 are situated along a bottom of each of the portions 510, 520, and 530, respectively (not shown in the FIG. 5).

In an embodiment, the interlocking mounting apparatus 500 includes two pins 501 and 502 that interlock the portions through apertures aligned along a top of each of the portions 510, 520, and 530 (such as through aperture 503 for the second portion 520) with pin 501 and that interlock the portions through apertures aligned along a bottom of each of the portions 510, 520, and 530 (such as through aperture 504 for the second portion 520).

In an embodiment, the interlocking mounting apparatus 500 includes a single pin 501 or 502 that interlocks the portions through apertures aligned along a top, a bottom, or a middle of each of the portions 510, 520, and 530 (not shown in the FIG. 5).

FIG. 6 is a diagram of a transparent view of the interlocking mounting apparatus of the FIG. 5, according to an example embodiment (and illustrated as interlocking mounting apparatus 600 in the FIG. 6).

The transparent view shows the apertures through which the pins 601 and 602 are inserted through the bodies of portions 610, 620, and 630 (such as aperture 604 of portion 610 and aperture 605 of portion 620). In the transparent view the mounting devices 615, 625, and 635 are visible a backside of the interlocking mounting apparatus 600.

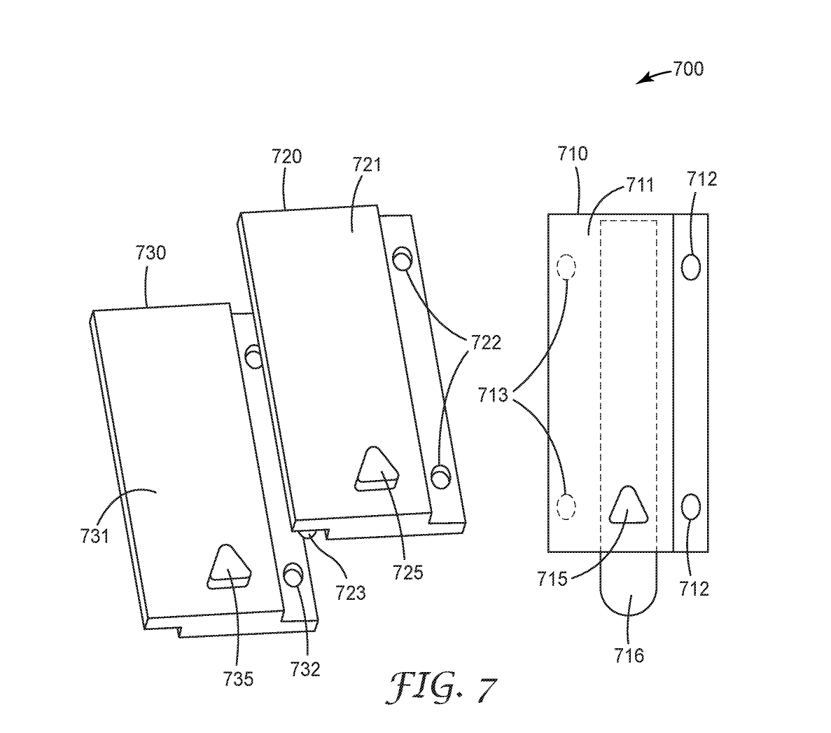

FIG. 7 is a diagram of a detached mounting apparatus 700 with three portions, according to an example embodiment.

The detached (not interlocked) mounting apparatus 700 includes a first portion 710, a second portion 720, and a third portion 730.

In an embodiment, the number of portions is configurable from 2 to N, where N is greater than 3 and the number of portions selected based on a weight load that is to be hung from one of the mounting devices of an assembled and interlocked version of the detached mounting apparatus 700.

The first portion 710 includes holes 712 along a first side and pins 713 along an opposing side. The front surface 711 of the first portion 710 includes a mounting device 715. A back surface of the first portion includes pins 713, and, optionally, an adhesive strip (as discussed above) 716. The holes 712 extend out on an extended portion of the front surface 711 that is depressed relative to the portion of the front surface 711 underlying mounting device 715 (as illustrated in FIG. 7).

Similarly, the second portion 720 includes a front surface 721 that includes an extended portion of the front surface 721 that is depressed and that includes the holes 722. The back surface of the second portion 720 includes pins 723 (only one pin illustrated in the FIG. 7). Optionally, the second portion 720 also includes a mounting device 725.

The third portion 730 includes a front surface 731 that includes an extended portion of the front surface 731 that is depressed and that includes the holes 732. The back surface of the third portion 730 includes pins (not illustrated in the FIG. 7). Optionally, the third portion 730 also includes a mounting device 735.

The detached mounting apparatus 700 is interlocked by aligning the holes of an extended portion on a front surface with pins on a back surface of a different portion and inserting the pins through the holes (such as snapping the pins into the holes as one example). This can be continued for adding additional portions to interlock two, three, or more portions together as an interlocked version of the detached mounting apparatus 700.

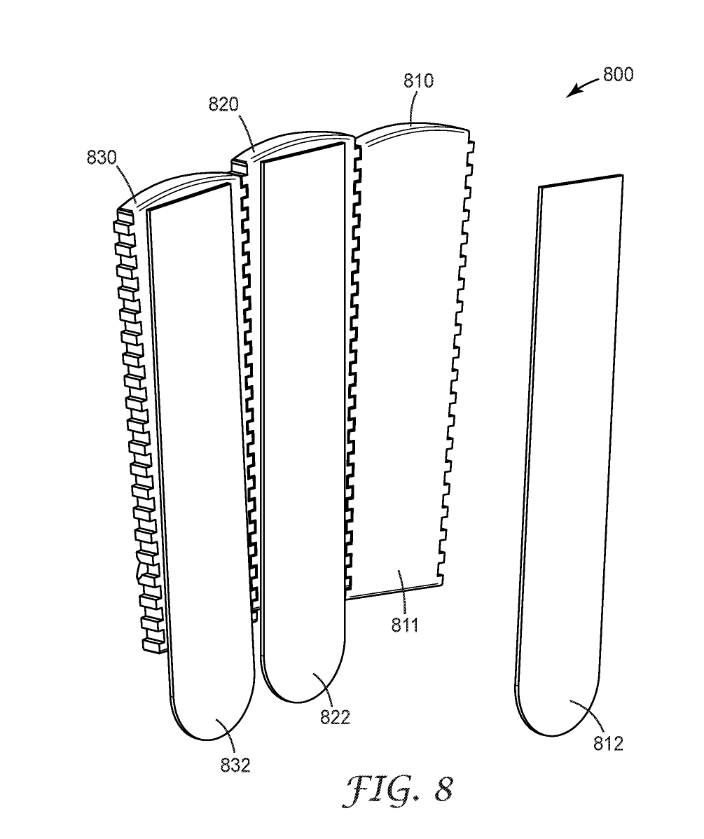

FIG. 8 is a diagram of backsides of a three portion interlocking mounting apparatus 800 interlocked by teeth with dual-sided adhesive strips (as described above), according to an example embodiment.

The interlocking mounting apparatus 800 includes portions 810, 820, and 830 interlocked together to form the interlocking mounting apparatus 800. The backside 811 of first portion 810 shows a detached view of an adhesive strip 812. A peel-away release media when peeled away exposes adhesive on a back surface of the adhesive strip 812 that can be then adhered to the backside surface 811 of the first portion.

The second portion 820 includes a view of an attached (adhered) adhesive strip 822 to a back surface of the second portion 820. Similarly, the third portion 830 includes a view of an attached (adhered) adhesive strip 832 to a back surface of the third portion 830.

The front surfaces of the adhesive strips 812, 822, and 832 also include peel-away release media that when peeled away exposes adhesive on the front surfaces to adhere the front surfaces of the adhesive strips to a vertical structure (wall, cabinet, locker, etc.)

In an embodiment, the backside surface 811 of the first portion 810 is premanufactured to include the back surface of the adhesive strip already adhered to the backside surface 811.

In an embodiment, the adhesive strips are included as components for assembly with each portion 810, 820, and 830.

In an embodiment, any of the previous-discussed embodiments for adhering the previous-discussed embodiments with adhesive strips can use any dual-sided adhesive substrate with release media on both sides of the substrate that when peeled away reveals adhesive for adhering to a back surface of one or more portions of an interlocking mounting apparatus and for adhering to a vertical structure from which the interlocking mounting apparatus is to be affixed to.

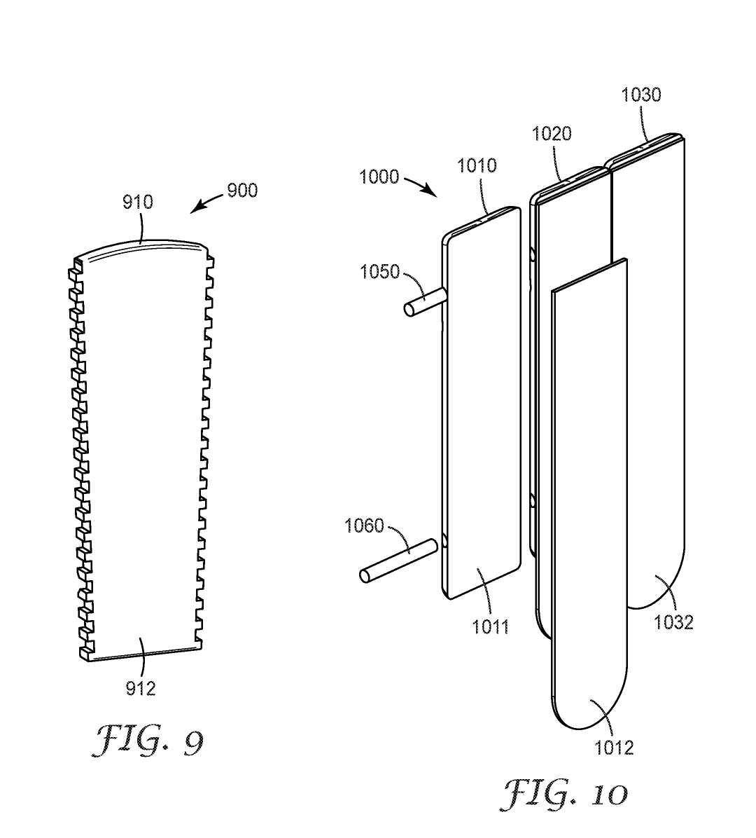

FIG. 9 is a diagram 900 of a backside of a single portion of an interlocking mounting apparatus, according to an example embodiment.

The diagram 900 illustrates that the backside surface of a portion of any of the above-mentioned interlocking mounting apparatuses for a single portion can include a pre-manufactured adhesive 912 having release media that when peeled away reveals adhesive 912 to affix that portion to a vertical structure.

FIG. 10 is a diagram of a backside view of a three portion interlocking mounting apparatus 1000 interlocked by pins with dual-sided adhesive strips, according to an example embodiment.

The interlocking mounting apparatus 1000 includes a first portion 1010, a second portion 1020, and a third portion 1030. The backside surface of the first portion 1010 shows a detached adhesive strip 1012 that can be attached to the backside surface 1011 of the first portion. The second portion 1020 and third portion 1030 include attached adhesive strips (e.g., attached adhesive strip 1032 to the backside surface of the third portion 1030).

The interlocking mounting apparatus 1000 is interlocked through pins 1050 and 1060 inserted through apertures in the portions 1010, 1020, and 1030.

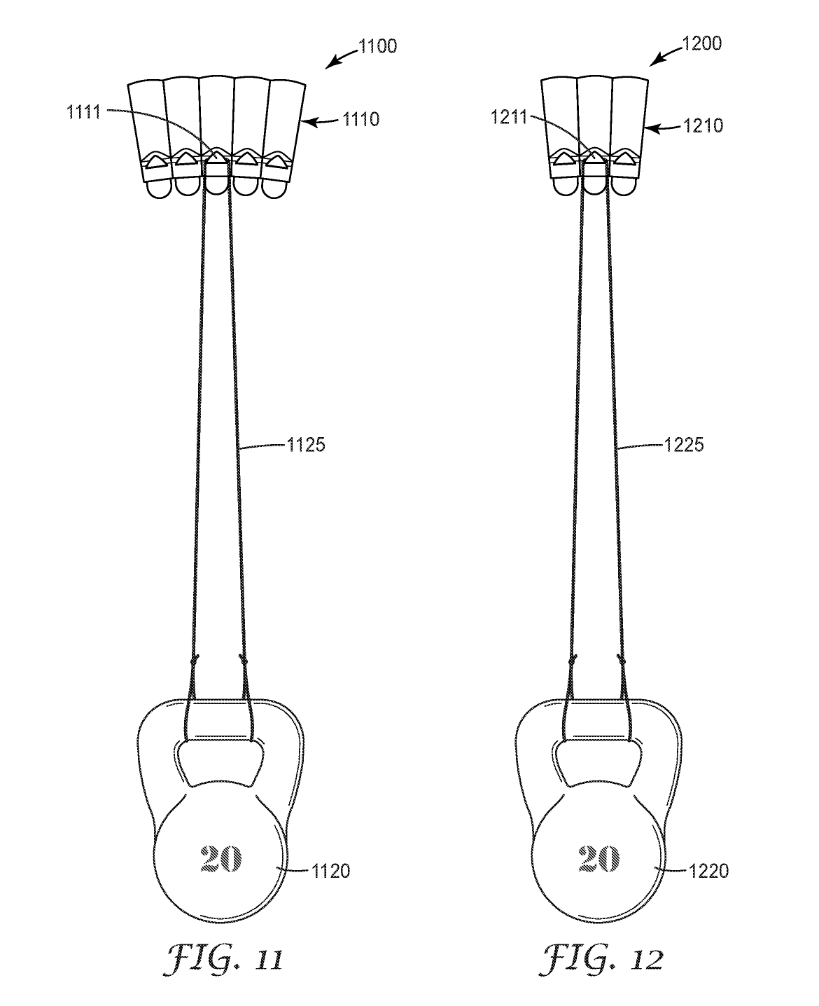

FIG. 11 is a diagram 1100 of five portion interlocking mounting apparatus 1110 holding a twenty pound weight, according to an example embodiment.

A conventional mounting device affixed to a wall is capable of holding roughly 5 pounds in weight hanging from that conventional mounting device.

The five-portion interlocking mounting apparatus 1110 illustrates 20 pounds of weight 1120 being hung by a chain 1125 from a single mounting device 1111 of the single interlocking mounting apparatus 1110 (comprising five interlocking portions).

It is noted that the arch formation (discussed above with the FIGS. 2-4) of the interlocking mounting apparatus 1110 assisted in distributing the weight amongst each of the interlocked portions for the interlocking mounting apparatus 1110.

FIG. 12 is a diagram 1200 of a three portion interlocking mounting apparatus 1210 holding a twenty pound weight 1220, according to an example embodiment.

The three-portion interlocking mounting apparatus 1110 illustrates 20 pounds of weight 1220 being hung by a chain 1225 from a single mounting device 1211 of the single interlocking mounting apparatus 1210 (comprising three interlocking portions).

As previously discussed each portion added to any of the novel interlocking mounting apparatuses discussed herein and above can increase the load of the mounting apparatus by a factor of 1.75.

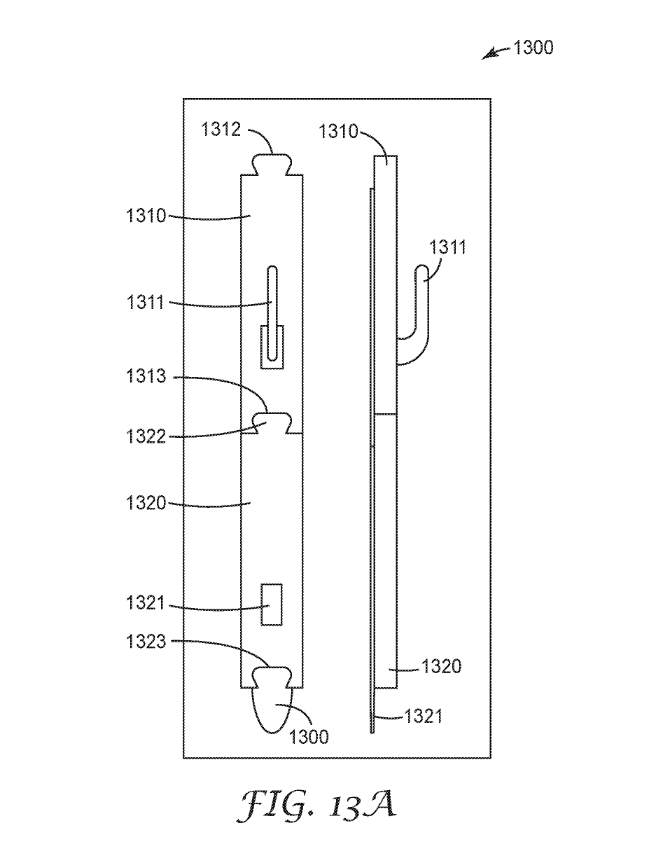

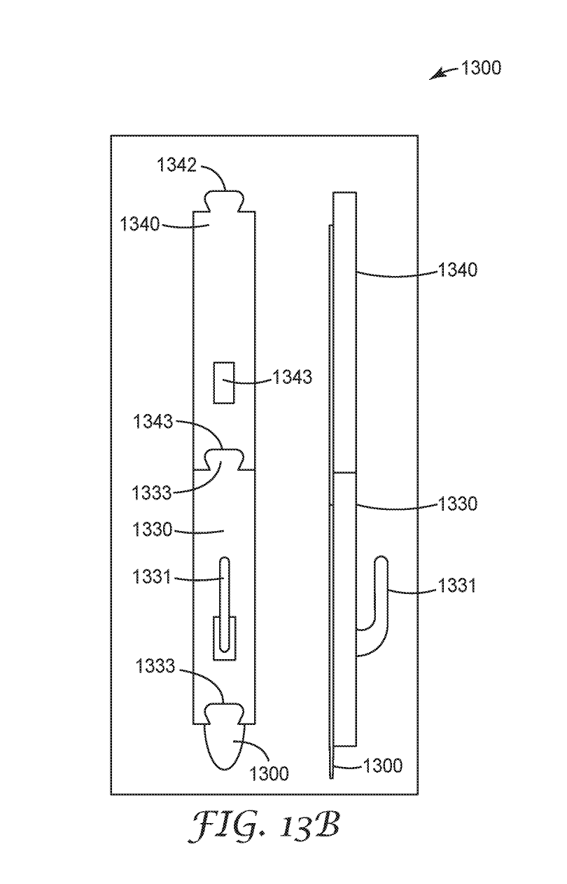

FIGS. 13A and 13B are each a diagram of vertically stacked interlocking mounting apparatuses 1300, according to example embodiments.

In a first embodiment depicted in FIG. 13A, a vertically stackable interlocking mounting apparatus includes two portions 1310 and 1320. The first portion 1310 includes a mounting device 1311, a protruding interlocking portion 1312 on a first end of the first portion 1310, and recessed portion 1313 on second end of the first portion 1310. The second portion 1320 includes a mounting device attachment portion 1321, a protruding interlocking portion 1322 and a recessed portion 1323. Backsides of the first portion 1310 and/or the second portion 1320 may also include an adhesive strip 1321 accessible from the bottom of the second portion 1320 for removing the vertically stackable interlocking mounting apparatus (1310 and 1320) from a structure to which the apparatus (1310 and 1320) is affixed/adhered to. The protruding portion 1322 of the second portion 1320 is adapted to be interlocked into the recessed portion 1313 of the first portion 1310 to form a single vertical apparatus (1310 and 1320).

FIG. 13A also illustrates a side view of the vertically stackable interlocking mounting apparatus (1310 and 1320) where the mounting device 1311 of the first portion 1310 is vertically stacked above the second portion 1320. The side view also illustrates that the adhesive strip extending over the backsides of both the first portion 1310 and the second portion 1320; this may be a single adhesive strip or two separate adhesive strips. In an embodiment, the adhesive strip(s) cover only a potion but not all of the backside of the first portion 1310. In an embodiment, the adhesive strip(s) cover all or substantially all of the backsides of the first portion 1310 and the second portion 1320. In an embodiment, the first portion 1310 includes a first adhesive strip on greater than 50% of a backside of the first portion 1310 with a portion of the first adhesive strip extending to a portion of a backside of the second portion 1320, and the second portion 1320 includes a second adhesive strip on greater than 50% of a backside of the second portion 1320 that begins adjacent to the first adhesive strip and extends past a bottom of the second portion 1320 having the mounting device 1311 of the first portion 1310 vertically stacked above the second portion 1320.

In another embodiment depicted in FIG. 13B, a vertically stackable interlocking mounting apparatus includes two portions 1330 and 1340. The first portion 1310 includes a mounting device 1331, a protruding interlocking portion 1332 on a first end of the first portion 1330, and recessed portion 1333 on second end of the first portion 1330. The second portion 1340 includes a mounting device attachment portion 1341, a protruding interlocking portion 1342 and a recessed portion 1343. Backsides of the first portion 1330 and/or the second portion 1340 may also include an adhesive strip 1334 accessible from the bottom of the first portion 1330 for removing the vertically stackable interlocking mounting apparatus (1330 and 1340) from a structure to which the apparatus (1330 and 1340) is affixed/adhered to. The protruding portion 1332 of the first portion 1330 is adapted to be interlocked into the recessed portion 1343 of the second portion 1340 to form a single vertical apparatus (1330 and 1340) having the mounting mechanism 1331 of the first portion 1330 vertically stacked below the second portion 1340.

FIG. 13B also illustrates a side view of the vertically stackable interlocking mounting apparatus (1330 and 1340) where the mounting apparatus 1331 of the first portion 1330 is vertically stacked below the second portion 1340. The side view also illustrates that the adhesive strip extending over the backsides of both the first portion 1330 and the second portion 1340; this may be a single Adhesive strip or two separate adhesive strips. In an embodiment, the adhesive strip(s) cover only a potion but not all of the backside of the first portion 1340. In an embodiment, the adhesive strip(s) cover all or substantially all of the backsides of the first portion 1330 and the second portion 1340. In an embodiment, the first portion 1340 includes a first adhesive strip on greater than 50% of a backside of the second portion 1340 with a portion of the first adhesive strip extending to a portion of a backside of the first portion 1330, and the first portion 1330 includes a second adhesive strip on greater than 50% of a backside of the first portion 1330 that begins adjacent to the first adhesive strip and extends past a bottom of the first portion 1330.

In an embodiment (not illustrated in the FIG. 13), the protruding members (1312, 1322, 1332, and 1342) are situated along a single side of the portions (1310, 1320, 1330, and 1340) and oriented horizontally (rather than vertically along an end portion as illustrated in the FIG. 13). The position of the protruding members (1312, 1322, 1332, and 1342) may be in the middles or near edges of the sides for the portions (1310, 1320, 1330, and 1340). Similarly, opposite sides (from the sides with the protruding members (1312, 1322, 1332, and 1342)) include recess portions (1313, 1323, 1333, and 1343) which are horizontally oriented. This permits interlocking between the protruding members (1312, 1322, 1332, and 1342) to interlock (for attachment and detachment) with corresponding recessed portions (1313, 1323, 1333, and 1343) in a horizontal fashion; rather than the vertical fashion depicted in the FIG. 13.

The mounting attachment mechanisms 1321 and 1341 permit additional mounting devices to be affixed and/or adhered to the second portion 1320 of the first vertically stackable mounting apparatus (1310 and 1320) and to the second portion 1340 of the second vertically stackable mounting apparatus (1330 and 1340).

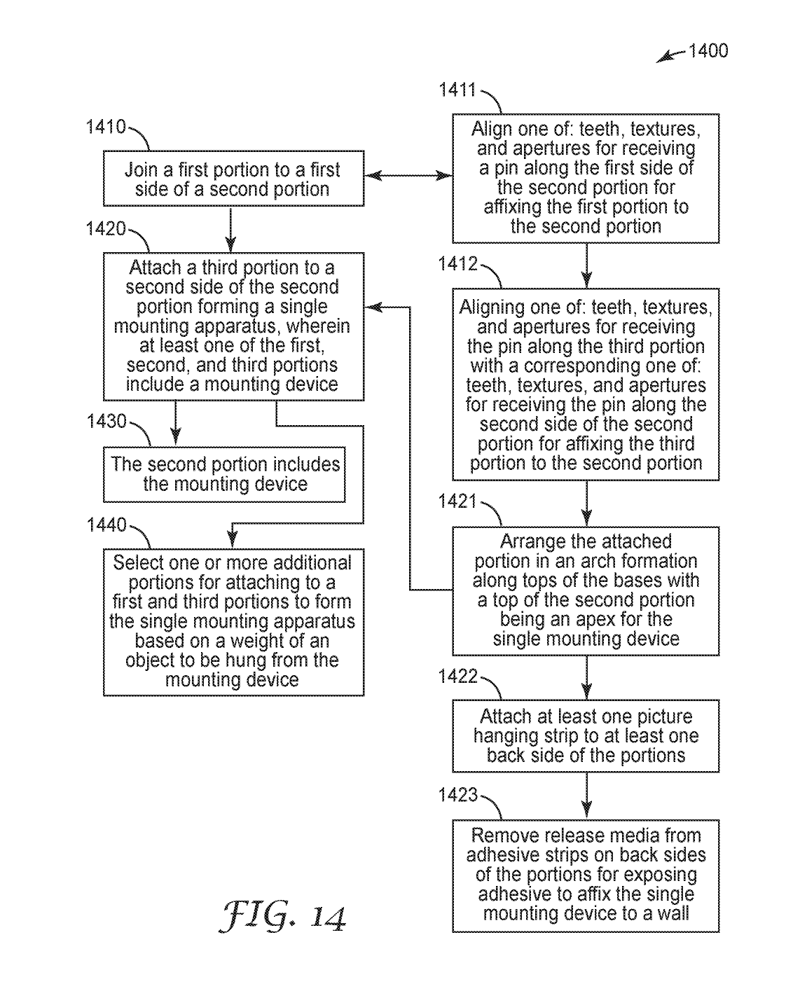

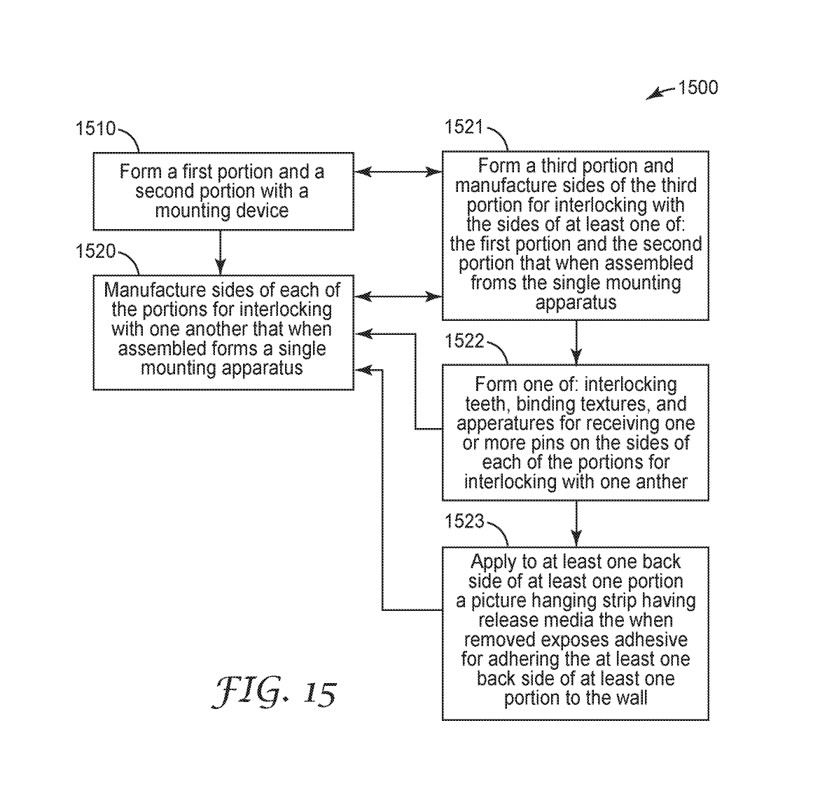

FIG. 14 is a diagram of a method 1400 for operating an interlocking mounting apparatus, according to an example embodiment.

At 1410, a first portion (or unit) is joined to a first side of a second portion (or unit).

In an embodiment, at 1411, the first portion is joined to the second portion by aligning: apertures for receiving a pin along the first side of the second portion, teeth, or textures for affixing and binding the first portion to the second portion.

At 1420, a third portion is attached to a second side of the second portion forming a single mounting apparatus, where at least one of the first, second, and third portions include a mounting device.

In an embodiment of 1420 and 1411, at 1412, the third portion is joined to the second portion by aligning: teeth, textures, and apertures for receiving the pin of a third portion with a corresponding one of: teeth, textures, and apertures for receive the pin along the second side of the second portion for affixing and binding the third portion to the second portion.

In any of the preceding embodiments, at 1421, the attached portions are arranged in an arch formation along tops of the portions with a top of the second portion being an apex for the single mounting apparatus.

In any of the preceding embodiments, at 1422, at least one adhesive strip is attached to at least one back side of the portions.

In any of the preceding embodiments, at 1423, release media is removed from adhesive strips on back sides of the portions for exposing adhesive to affix the single mounting device to a wall.

In an embodiment, at 1430, the second portion includes the mounting device.

In an embodiment, at 1440, one or more additional portions are selected for attaching to the first and third portions to form the single mounting apparatus based on a weight of an object to be hung from the mounting device.

FIG. 15 is a diagram of a method 15000 for manufacturing an interlocking mounting apparatus, according to an example embodiment.

At 1510, a first portion is formed and a second portion is formed having a mounting device.

At 1520, sides of each of the portions are manufactured for interlocking with one another that when assembled forms a single mounting apparatus.

In an embodiment, at 1521, a third portion is formed and the sides of the third portion manufactured for interlocking with the sides of at least one of: the first portion and the second portion that when assembled forms the single mounting apparatus.

In an embodiment, at 1522, the manufactured sides include forming one of: interlocking teeth, binding textures, and apertures for receiving one or more pins on the sides of each of the portions for interlocking with one another.

In any of the preceding embodiments, at 1523, an adhesive strip is applied to at least one back side of at least one portion. The adhesive strip having release media that when removed exposes adhesive for adhering the at least one back side of the at least one portion to a wall.

### Embodiments

1. An apparatus, comprising: a first portion; and a second portion including a mounting device; wherein the first portion is adapted to interlock with the second portion to form a single mounting apparatus.

2. The apparatus of embodiment 1, wherein the first portion and the second portion comprise teeth to interlock the first portion with the second portion.

3. The apparatus of embodiment 2, wherein the teeth are square shaped.

4. The apparatus of embodiment 2, wherein the teeth are arranged in a wave shape.

5. The apparatus of embodiment 1, wherein the first portion and the second portion include apertures for receiving a pin to interlock the first portion with the second portion.

6. The apparatus of embodiment 1, wherein the first portion and the second portion include textures that are adapted to bind the first portion with the second portion.

7. The apparatus of any of the preceding embodiments 1-6, wherein non-interlocking sides of the first portion and the second portion comprise additional teeth, additional apertures, or additional textures for adding one or more additional portions adjacent to the first portion and second portions as part of the single mounting apparatus.

8. The apparatus of any of the preceding embodiments 1-7, wherein the mounting device is a hook is shaped as a truncated triangle situated along a bottom of the second portion.

9. The apparatus of any of the preceding embodiments 1-7, wherein the mounting device is one of: a hook, a clip, a loop, and a sawtooth.

10. The apparatus of embodiment 1, wherein the first portion when interlocked with the second portion forms an arch formation.

11. The apparatus of any of the preceding embodiments 1-10, wherein a back side of each portion includes a removable dual-sided adhesive strip.

12. The apparatus of embodiment of any of the preceding embodiments 1-10, wherein a back side of each portion includes an adhesive strip.

13. The apparatus of embodiment 1, wherein the mounting device is adapted to hold an object hanging vertically from the single mounting apparatus while back sides of the portions are adhered to a wall, and single mounting apparatus is adapted to distribute a vertical force from the object hanging vertically from the mounting device amongst the portions.

14. An apparatus, comprising: a first portion; a second portion; and a third portion; wherein at least one of the first, second, and third portions includes a mounting device, and wherein the portions are adapted to be interlocked together to form a single mounting apparatus.

15. The apparatus of embodiment 14 further comprising, a fourth potion adapted to interlock within one of the first, second, and third portions to form the single mounting apparatus.

16. The apparatus of embodiment 14, wherein the first, second and third portions include one of: teeth, textures, and apertures to receive a pin for interlocking the portions together to form the single mounting apparatus.

17. The apparatus of embodiment 16, wherein when the first, second and third portions include the apertures, the apertures are situated and aligned with another along at least one of: tops, middles, and bottoms of the portions.

18. The apparatus of embodiment 17, wherein the first, second and third portions include second apertures along another of at least one of: the tops, the middles, and the bottoms.

19. The apparatus of any of the embodiments 14-18, wherein a back side of each portion includes a removable dual-sided adhesive strip.

20. The apparatus of any of the embodiments 14-18, wherein a back side of each portion includes a picture hanging strip.

21. The apparatus of embodiment 9, wherein the portions are adapted to act as a single unit for distributing load bearing forces that hang from the mounting device on the single mounting apparatus.

22. A method of forming a mounting apparatus, comprising: joining a first portion to a first side of a second portion; and attaching a third portion to a second side of the second portion forming a single mounting apparatus; wherein at least one of the first, second, and third portions include a mounting device.

23. The method of embodiment 22, wherein the second portion includes the mounting device.

24. The method of embodiment 22, wherein joining further includes aligning one of: teeth, textures, and apertures for receiving a pin of the first portion with a corresponding one of: teeth, textures, and apertures for receiving the pin along the first side of the second portion for affixing the first portion to the second portion.

25. The method of embodiment 24, wherein attaching further includes aligning one of: teeth, textures, and apertures for receiving the pin of the third portion with a corresponding one of: teeth, textures, and apertures for receiving the pin along the second side of the second portion for affixing the first portion to the second portion.

26. The method of any of the preceding embodiments 22-25 further comprising arranging the attached portions in an arch formation along tops of the bases with a top of the second portion being an apex for the single mounting apparatus.

27. The method of any of the preceding embodiments 22-26 further comprising, attaching at least one picture hanging strip to at least one back side of the portions.

28. The method of any of the preceding embodiments 22-26 further comprising, removing release media from adhesive strips on back sides of the portions for exposing adhesive to affix the single mounting device to a wall.

29. The method of embodiment 22 further comprising, selecting one or more additional portions for attaching to the first and third portions to form the single mounting apparatus based on a weight of an object to be hung from the mounting device.

30. A method, comprising: forming a first portion and a second portion with a mounting device; and manufacturing sides of each of the portions for interlocking with one another that when assembled forms a single mounting apparatus.

31. The method of embodiment 30, wherein forming includes forming a third portion and wherein manufacturing further includes manufacturing sides of the third portion for interlocking with the sides of at least one of: the first portion and the second portion that when assembled forms the single mounting apparatus.

32. The method of embodiment 30, wherein manufacturing further includes forming one of: interlocking teeth, binding textures, and apertures for receiving one or more pins on the sides of each of the portions for interlocking with one another.

33. The method of any of the preceding embodiments 30-32, wherein manufacturing further includes applying to at least one back side of at least one portion a picture hanging strip having release media that when removed exposes adhesive for adhering the at least one back side of the at least one portion to a wall.

34. A mounting apparatus, comprising: a first unit; a second unit; a third unit; one or more connection devices that interlock the first, second, and third units; and a mounting device on at least one of: the first, second, and third units; wherein the interlocked first, second, and third units are adapted to distribute weight of an object to be hung on the mounting device over the first, second, and third units.

35. The mounting apparatus of embodiment 34, wherein the mounting device integrated within one of the: first, second, and third units can hold more weight than a single one of the units alone.

36. The mounting apparatus of embodiment 35 further comprising a fourth unit interlocked with the first, second, and third units, wherein the mounting device integrated within one of the: first, second, and third units can hold more weight than the first, second, and third units.

37. The mounting apparatus of any of the preceding embodiments 34-36, wherein the one or more connection devices comprise one of: interlocking teeth, binding textures, and apertures for receiving one or more pins.

38. The mounting apparatus of any of the preceding embodiments 34-37, wherein the mounting device is one of: a hook, a clip, a loop, and a sawtooth.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

What is claimed is:

1. An apparatus, comprising:
a first portion; and
a second portion including a mounting device;
wherein the first portion is adapted to interlock with the second portion to form a single mounting apparatus.

2. The apparatus of claim 1, wherein the first portion and the second portion comprise at least one of teeth to interlock the first portion with the second portion, apertures for receiving a pin to interlock the first portion with the second portion, and textures that are adapted to bind the first portion with the second portion.

3. The apparatus of claim 1, wherein non-interlocking sides of the first portion and the second portion comprise additional teeth, additional apertures, or additional textures for adding one or more additional portions adjacent to the first portion and second portions as part of the single mounting apparatus.

4. The apparatus of claim 1, wherein the mounting device is one of: a hook, a clip, a loop, and a sawtooth.

5. The apparatus of claim 1, wherein the first portion when interlocked with the second portion forms an arch formation.

6. The apparatus of claim 1, wherein a back side of at least one portion includes a dual-sided adhesive strip.

7. The apparatus of claim 1, wherein the mounting device is adapted to hold an object hanging vertically from the single mounting apparatus while back sides of the portions are adhered to a wall, and single mounting apparatus is adapted to distribute a vertical force from the object hanging vertically from the mounting device amongst the portions.

8. An apparatus, comprising:
a first portion;
a second portion; and
a third portion;
wherein at least one of the first, second, and third portions includes a mounting device, and wherein the portions are adapted to be interlocked together to form a single mounting apparatus.

9. The apparatus of claim 8 further comprising, a fourth potion adapted to interlock within one of the first, second, and third portions to form the single mounting apparatus.

10. The apparatus of claim 8, wherein the first, second and third portions include one of: teeth, textures, and apertures to receive a pin for interlocking the portions together to form the single mounting apparatus.

11. The apparatus of claim 10, wherein when the first, second and third portions include the apertures, the apertures are situated and aligned with another along at least one of: tops, middles, and bottoms of the portions.

12. The apparatus of claim 11, wherein the first, second and third portions include second apertures along another of at least one of: the tops, the middles, and the bottoms.

13. The apparatus of claim 8, wherein a back side of at least one portion includes a dual-sided adhesive strip.

14. A method, comprising:
forming a first portion and a second portion with a mounting device; and
manufacturing sides of each of the portions for interlocking with one another that when assembled forms a single mounting apparatus.

15. The method of claim 14, wherein forming includes forming a third portion and wherein manufacturing further includes manufacturing sides of the third portion for interlocking with the sides of at least one of: the first portion and the second portion that when assembled forms the single mounting apparatus.

16. The method of claim 14, wherein manufacturing further includes forming one of: interlocking teeth, binding textures, and apertures for receiving one or more pins on the sides of each of the portions for interlocking with one another.

17. The method of claim 14, wherein manufacturing further includes applying to at least one back side of at least one portion a dual-sided adhesive having release media that when removed exposes adhesive for adhering the at least one back side of the at least one portion to a wall.

18. The method of claim 15 and further comprising, selecting one or more additional portions for attaching to the first and third portions to form a single mounting apparatus based on a weight of an object to be hung from the mounting device.

19. The method of claim 14, wherein interlocking further includes aligning one of: teeth, textures, and apertures for receiving a pin of the first portion with a corresponding one of: teeth, textures, and apertures for receiving the pin along the first side of the second portion for affixing the first portion to the second portion.

20. The method of claim 14 and further comprising arranging the portions in an arch formation along tops of the bases with a top of the second portion being an apex for the single mounting apparatus.
